(19) United States
(12) Patent Application Publication
(10) Pub. No.: US 2013/0105011 A1
(43) Pub. Date: May 2, 2013

(54) LIQUID-SUPPLY APPARATUS

(71) Applicant: Shanghai Kohler Electronics, Ltd., Shanghai (CN)

(72) Inventors: Jing Li, Shanghai (CN); Sheng Yun, Hubei Province (CN); Jian Zhang, Shanghai (CN)

(73) Assignee: Shanghai Kohler Electronics, Ltd., Shanghai (CN)

(21) Appl. No.: 13/664,058

(22) Filed: Oct. 30, 2012

(30) Foreign Application Priority Data
Oct. 31, 2011 (CN) 201110338967.7
Oct. 31, 2011 (CN) 201120424883.0

(51) Int. Cl. F16L 55/00

(52) U.S. Cl. CPC F16L 55/00
USPC 137/565.01

(57) ABSTRACT

A liquid supply apparatus (e.g., for dispensing soap, shampoo, etc.) includes a liquid storage tank and a pump module connected to the storage tank. The liquid supply apparatus further includes a suck-back module. The suck-back module includes a chamber formed by a piston cover disposed at an end of a cylinder, a piston rod having a first end disposed in the chamber and a second end configured to extend through an opening in the piston cover, and a plug disposed in the chamber and connected to the first end of the piston rod.

### CROSS-REFERENCE TO RELATED PATENT APPLICATIONS

This application claims the benefit of and priority to China P.R. Priority Application No. 201120424883.0, filed on Oct. 31, 2011 and China P.R. Priority Application No. 201110338967.7, filed on Oct. 31, 2011. The foregoing applications are incorporated by reference herein in their entireties.

### BACKGROUND

The present application relates generally to the field of liquid supply apparatuses for liquid dispensers (e.g., liquid soap, a disinfectant liquid, a softener, a shower gel, a shampoo, a hand cleanser liquid, etc.). More specifically, the present application relates to a liquid supply apparatus that is able to suck back (e.g., withdraw, retract, etc.) the liquid to prevent the liquid from dripping and from being contaminated.

FIG. 1 illustrates a conventional liquid supply apparatus having a liquid storage tank 1′, a pump module 2′, a cam 3′, a motor 4′, a liquid transport pipe 5′, a nozzle module 6′, and a power supply module (not shown in the figure). The liquid storage tank 1′ is used for storing liquid; the pump module 2′ is connected to the liquid storage tank 1′; the power supply module supplies the driving force for the motor 4′; as driven by the motor 4′, the cam 3′ presses the pump module 2′ to press the liquid in the liquid storage tank l′ into the liquid transport pipe 5′; and the nozzle module 6′ delivers the liquid.

Conventional liquid supply apparatuses, such as the liquid supply apparatus shown in FIG. 1, generally have several deficiencies or problems. First, after use of the liquid supply apparatus, a large quantity of the liquid remains in the liquid transport pipe and at the outlet of the nozzle. Accordingly, if there is no other control apparatus, then the liquid remaining in the pipe will inevitably drip down when the apparatus is not in use, resulting in the contamination of another object (e.g., a desktop, a floor, etc.) and the waste of the liquid. Second, if the liquid supply apparatus is not used for a long period of time, then the liquid remaining in the pipe may coagulate, such as, upon drying and thereby clog the pipeline, which may lead to the liquid supply apparatus being inoperable. Additionally, the liquid remaining in the pipe may be contaminated to various degrees, such as, due to exposure to the external elements (e.g., the air) for a period of time (e.g., a long period of time). Further, the contaminated liquid remaining in the pipe may be mixed with new (i.e., uncontaminated) liquid that is pumped from the liquid storage tank during the next use or operation of the liquid supply apparatus. As a result, the purity of the delivered liquid may be comprised and accordingly, may not be guaranteed. Further, the contaminated liquid may adversely affect the overall performance of the liquid being supplied. In other words, the liquid that has been contaminated may not perform as well as the liquid that has not been contaminated.

### SUMMARY

An exemplary embodiment relates to a liquid supply apparatus (e.g., for dispensing soap, shampoo, etc.) having a liquid storage tank and a pump module connected to the liquid storage tank. In an exemplary embodiment, the pump module is disposed at a side of a cam and configured to engage the cam. The liquid supply apparatus also includes a driving module for controlling the rotation of the cam, a liquid transport pipe having a first end connected to the pump module and a second end connected to a nozzle module, a suck-back module, and a transmission module connected to the suck-back module. The transmission module has an end that is disposed at a second side of the cam and is configured to abut the cam. The liquid supply apparatus also includes a first return pipe and a second return pipe. The first return pipe includes a first end connected to the suck-back module, a second end connected to the liquid transport pipe, and a first check valve disposed therein. The second return pipe includes a first end connected to the liquid storage tank, a second end connected to the suck-back module, and a second check valve disposed therein.

Another exemplary embodiment relates to a suck-back module for use in a liquid supply apparatus (e.g., for dispensing soap, shampoo, etc.). The suck-back module includes a chamber formed by a piston cover disposed at an end of a cylinder, a piston rod having a first end disposed in the chamber and a second end configured to extend through an opening in the piston cover, and a plug disposed in the chamber and connected to the first end of the piston rod.

The suck-back module may also include a biasing member that is disposed in the chamber and is configured to bias the piston rod relative to the one of the piston cover and the cylinder. The plug may be attached to an inner surface of a wall of the cylinder where the biasing member has a first end configured to abut the plug and a second end configured to abut an inner surface of the piston cover.

Yet another exemplary embodiment relates to a liquid supply apparatus including a driving module for controlling the rotation of a cam, a pump module configured to pump a liquid to a transport pipe, a return pipe, a suck-back module, and a transmission module. The return pipe includes a first end, a second end fluidly connected to the transport pipe, and a check valve provided between the first and second ends. The suck-back module is fluidly connected to the first end of the return pipe and is configured to suck-back the liquid in the transport pipe and the return pipe. The suck-back module includes a chamber formed by a cover disposed at an end of a cylinder, and a piston rod having a piston portion disposed in the chamber and a rod portion extending from the piston portion through an opening in the cover. The transmission module is connected to the rod portion of the piston rod and is configured to move, such that movement of the transmission module moves the rod portion. The operation of the pump module and the transmission module are configured to be controlled by the rotation of the cam.

Thus, an objective of the present application is to overcome the drawbacks of conventional devices by providing a liquid supply apparatus having an assembly (e.g., a suck-back module) that is configured to suck back (e.g., withdraw, retract) the liquid provided in a dispensing tube or pipe and/or nozzle to thereby prohibit the liquid from dripping and from being contaminated.

In an exemplary embodiment, the liquid supply apparatus as disclosed in the present application may include a liquid storage tank and a pump module connected to the liquid storage tank. The pump module may be disposed at one side of a cam and may abut the cam. The liquid supply apparatus may further include a driving module for controlling the rotation of the cam. The liquid supply apparatus may yet further include a liquid transport pipe with one end connected to the pump module and another end connected to a nozzle module. The liquid supply apparatus may further include a suck-back module, a transmission module connected to the suck-back module, a first return pipe, and a second return pipe. One end of the transmission module may be disposed at a side of the cam that is opposite the pump module, such that the end may abut the cam. One end of the first return pipe may be connected to the suck-back module and another end may be connected to the liquid transport pipe. A first check valve may be disposed in the first return pipe. One end of the second return pipe may be connected to the liquid storage tank and another end may be connected to the suck-back module. A second check valve may be disposed in the second return pipe.

The suck-back module may include a cylinder forming a chamber, a piston rod disposed inside the cylinder chamber having one end provided with a rubber plug that may be contacting or attached to an inner wall of the cylinder and another end configured to run or extend through a piston cover. The piston rod may be fitted over by a spring having one end configured to abut an inner surface of the piston cover and another end configured to abut the rubber plug. The piston cover may be coupled or connected to the cylinder to thereby define and form the chamber.

The transmission module may include a motion bar and a connection part. A free end of the motion bar may be configured to abut the cam, and a fixed end of the motion bar may be pivotally coupled (e.g., hinged) to a fixed base. One end of the connection part may be connected to the motion bar, and the other end of the connection part may be connected to the piston rod.

An opening may be formed on the motion bar, and a projection may be formed on a top surface of the motion bar at the position corresponding to the opening. The connection part may be configured to be coupled to (e.g., hung from, suspended from) the projection, such as by running or extending through the opening.

The projection may be configured as a cylindrical support rod, and the cylindrical support rod may be formed with or installed on a square support base. The connection part may be a flexible connection rope having a ring end configured to fit over the cylindrical support rod. The connection part may be a rigid connection rod.

A generally triangular shaped portion may be formed at a side of the opening on a bottom surface of the motion bar, where the side may be closer to the fixed end than the free end. A side of the triangle portion may correspond to a position of the opening and may extend downward to form a curved edge. A groove may be formed on the curved edge. A side of the triangle portion may be configured to be perpendicular to the motion bar to thereby form a vertical side, where the vertical side is provided with a through hole that corresponds to the position of the opening. A side edge of a longitudinal section of the through hole that is closer to the fixed end may be a curve.

The liquid transport pipe may include a first liquid transport pipe and a second liquid transport pipe. One end of the first liquid transport pipe may be connected to the pump module. One end of the second liquid transport pipe may be connected to the nozzle module. The liquid supply apparatus may also include a three-way connection module configured to connect to the first liquid transport pipe, the second liquid transport pipe, and the first return pipe.

The liquid storage tank may store a liquid soap, a disinfectant liquid, a softener, a shower gel, a shampoo, a hand cleanser liquid, or any combination thereof.

The liquid supply apparatuses as disclosed herein having a suck-back module may advantageously suck any liquid remaining in a liquid transport pipe and/or a nozzle module, such as after each use of the apparatus, back into a storage chamber, such as a liquid storage pipe, under the control of a transmission module and a driving module to thereby prohibit dripping and/or contamination of the residual liquid. Thus, the liquid supply apparatuses as disclosed herein may advantageously save liquid and extend the shelf life and/or the service life of the liquid.

### BRIEF DESCRIPTION OF THE DRAWINGS

FIG. 1 is a perspective view of a conventional liquid supply apparatus.

FIG. 2 is a perspective view an exemplary embodiment of a liquid supply apparatus, according to an exemplary embodiment.

FIG. 3 is an exploded view of an exemplary embodiment of a suck-back module for use in a liquid supply apparatus, such as the liquid supply apparatus of FIG. 2.

FIG. 4A is a front cross-sectional view of a liquid supply apparatus configured in a nonuse state, according to an exemplary embodiment.

FIG. 4B is a front cross-sectional view of a liquid supply apparatus in a liquid pumping state, according to an exemplary embodiment.

FIG. 4C is a front cross-sectional view of a liquid supply apparatus in a liquid pumping completion state, according to an exemplary embodiment.

FIG. 4D is a front cross-sectional view of a liquid supply apparatus in a suck-back state, according to an exemplary embodiment.

FIG. 4E is a front cross-sectional view of a liquid supply apparatus in a recovering state, according to an exemplary embodiment.

FIG. 5 is an exploded view of an exemplary embodiment of a transmission module for use in a liquid supply apparatus.

FIG. 6A is a top view of a portion of the transmission module of FIG. 5.

FIG. 6B is a front view of a portion of the transmission module of FIG. 5.

FIG. 6C is a front cross-sectional view of a portion of the transmission module of FIG. 5 taken along line A-A in FIG. 6A.

FIG. 7A is a disassembled perspective view of a suck-back module and a connection part for use in a liquid supply apparatus, according to an exemplary embodiment.

FIG. 7B is an assembled perspective view of the suck-back module and the connection part of FIG. 7A.

FIG. 8 is a front cross-sectional view of a liquid supply apparatus, according to an exemplary embodiment.

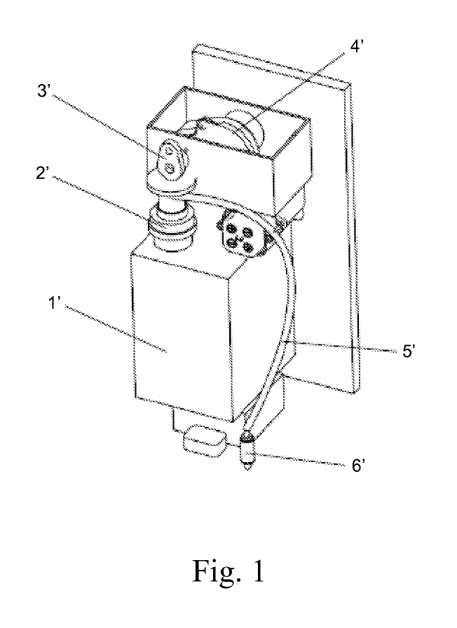

### DETAILED DESCRIPTION

With general reference to the Figures, disclosed herein are liquid supply apparatuses having suck-back modules that are configured to retract (e.g., suck-back, withdraw) residual liquid from a transport pipe that is fluidly connected to a nozzle module that dispenses the liquid. The operation of the suck-back module may be controlled by a transmission module and/or the driving module to thereby operate the suck-back module following a supply of the liquid being dispensed from the liquid supply apparatus. Accordingly, the suck-back module may withdraw any liquid remaining in the transport pipe and/or the nozzle module back into a chamber or any suitable device of the apparatus, such as, for example, after each use of the apparatus, to effectively prohibit the residual liquid from dripping from the nozzle and from being contaminated. Thus, the residual liquid may be saved thereby extending the shelf life and/or service life of the liquid.

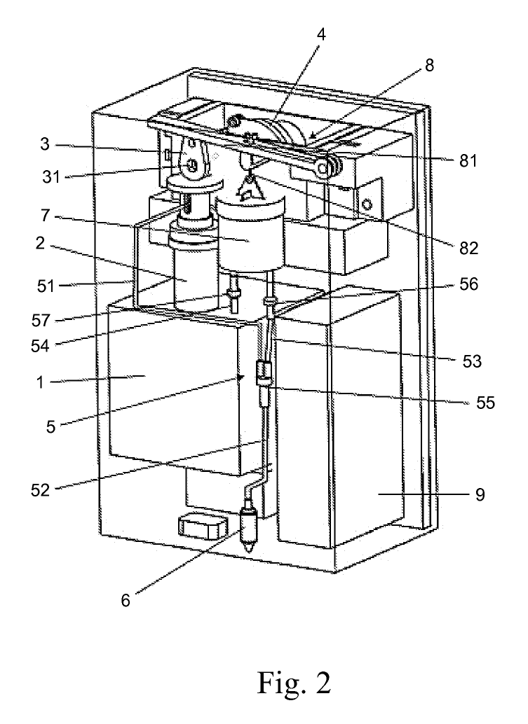

FIG. 2 illustrates a structure of a liquid supply apparatus, according to an exemplary embodiment. As shown, the liquid supply apparatus includes a liquid storage tank 1, a pump module 2 connected to the liquid storage tank 1, a cam 3, a driving module 4, a liquid transport pipe 5, a nozzle module 6, a suck-back module 7, a first return pipe 53, and a first check valve 56. The pump module 2 may be configured to facilitates pumping of the liquid from the liquid storage tank 1 to the liquid transport pipe 5. The pump module 2 may be disposed at a first side of the cam 3 and may be configured to engage (e.g., abut, cam against, contact, etc.) the cam 3. The driving module 4 may be configured to control the rotation of the cam 3. The liquid transport pipe 5 may have a first end connected to the pump module 2 and a second end connected to a nozzle module 6. The transmission module 8 may be connected to the suck-back module 7 and may include an end disposed at a second side of the cam 3. The end of the transmission module 8 may be configured to engage (e.g., abut, cam against, contact, etc.) the cam 3. The first return pipe 53 may include a first end connected to the suck-back module 7 and a second end connected to the liquid transport pipe 5. The first check valve 56 may be disposed in the first return pipe 53,

The liquid supply apparatus may also include a second return pipe 54 and a second check valve 57. The second return pipe 54 may include a first end connected to the liquid storage tank 1 and a second end connected to the suck-back module 7. The second check valve 57 may be disposed in the second return pipe 54.

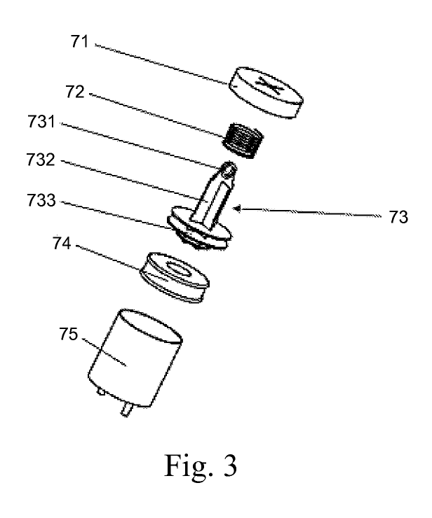

FIG. 3 illustrates an exemplary embodiment of the suck-back module 7 including a chamber that is formed or defined by a piston cover 71 disposed at an end of a cylinder 75, a piston rod 73, and a plug 74. The piston cover 71 may be connected to the cylinder 75 to form the chamber. The piston rod 73 may have a first end (e.g., a piston) disposed inside the chamber (e.g., of the cylinder 75) and a second end (e.g., a rod) configured to extend through an opening (e.g., aperture) in the piston cover 71. For example, the second end of the piston rod 73 may be configured having a shape, such as a cross shape, forming a cross bar 732, and the opening in the piston cover 71 may be similarly configured to allow the second end of the piston rod 73 to pass through the opening. The plug 74 may be made of any suitable material, such as an elastomeric material (e.g., rubber), and may be disposed in the chamber. The plug 74 may be connected to the first end of the piston rod 73. For example, the plug 74 may form a cavity configured to receive the first end of the piston rod 73 therein. The plug 74 may be configured to contact or abut to an inner wall of the cylinder 75 to form a seal therebetween, such as during movement of the plug 74 relative to the inner wall of the cylinder 75. Alternatively, the plug 74 may be configured to attach or couple to an inner wall of the cylinder 75.

The suck-back module 7 may also include a biasing member that is configured to bias the piston rod 73 relative to the piston cover 71 and/or the cylinder 75. As shown in FIG. 3, the biasing member is configured as a spring 72 having a coil or helical shape. However, it is noted that any suitable biasing member may be used to provide a biasing force to the piston rod 73. For example, the spring 72 may have a first end that is configured to abut the plug 74 and a second end that is configured to abut an inner surface of the piston cover 71. The spring 72 may be configured to apply a biasing force onto the piston.

FIG. 5 illustrate an exemplary embodiment of the transmission module 8 including a motion bar 81 and a connection part 82. The motion bar 81 has a free end 811 configured to engage (e.g., abut, contact against, etc.) the cam 3 and a fixed end 812 that is hinged to a fixed base 86. For example, the fixed end 812 of the motion bar 81 may be pivotally coupled or connected to the fixed base 86 through a connection pin 83. The connection pin 83 may pass through a hole in the fixed end 812 to engage the fixed base 86 to allow the motion bar 81 to move (e.g., rotate, pivot) relative to the fixed base 86. The connection part 82 may include a first end that is configured to connect to the motion bar 81 and a second end that is configured to connect to the piston rod 73. Thus, movement (e.g., rotation) of the motion bar 81 may translate into movement (e.g., sliding) of the piston rod 73, because the connection part 82 transfers the movement from the motion bar 81 to the piston rod 73.

The liquid supply apparatus may operate in one or more than one mode or state. For example, an exemplary embodiment of the liquid supply apparatus have five modes of operation, where the first is a nonuse state, the second is a liquid pumping state, the third is a liquid pumping completion state, the fourth is a suck-back state, and the fifth is a recovering state.

<Nonuse State>

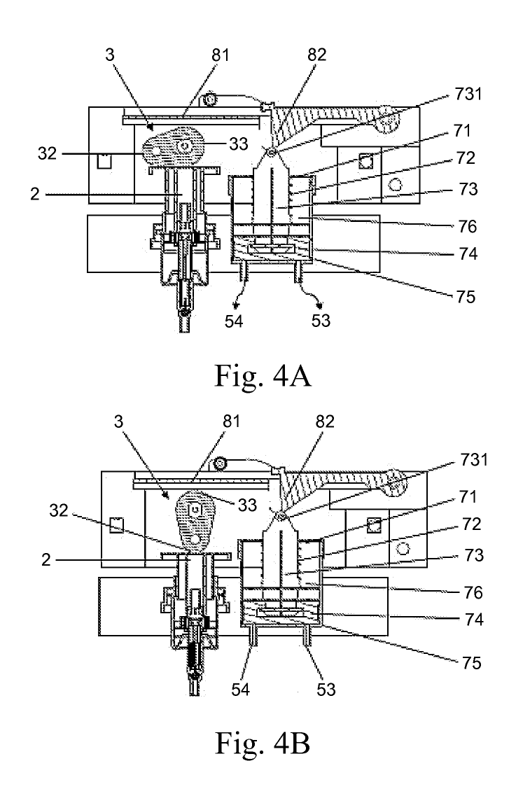

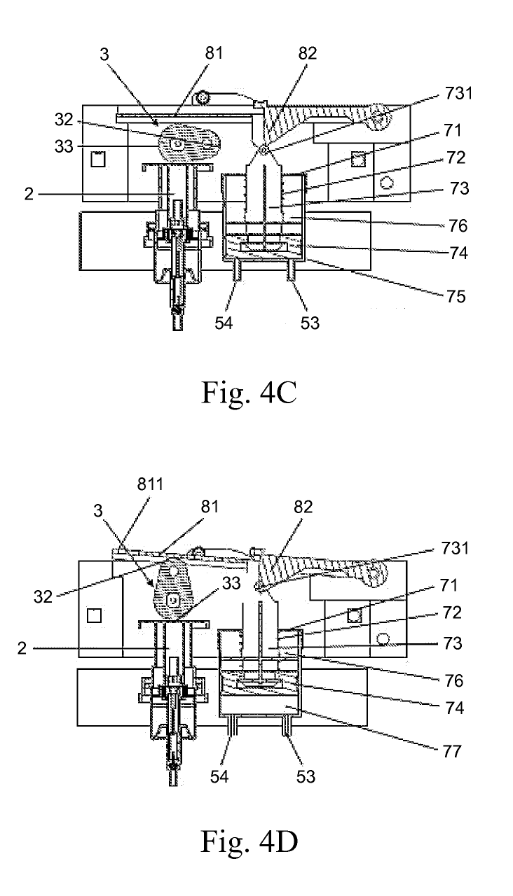

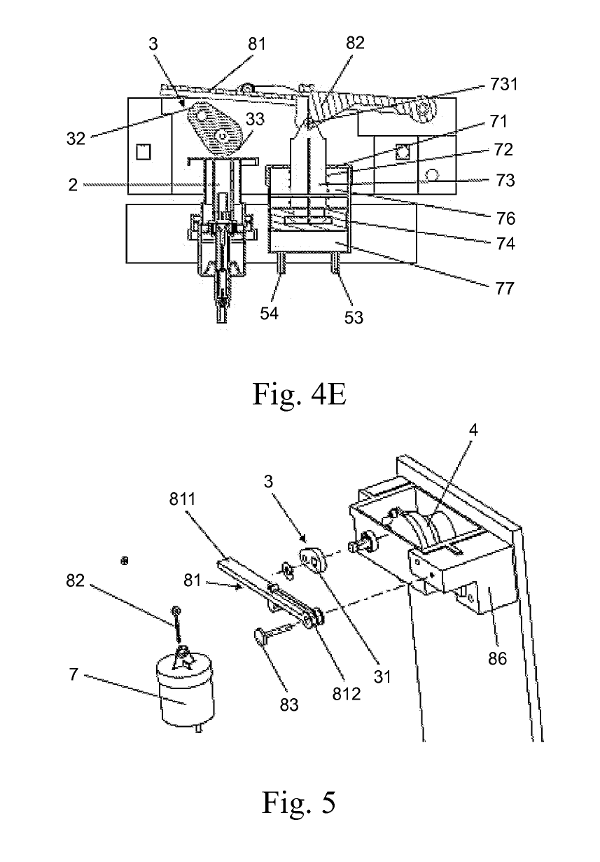

FIG. 4A illustrates the liquid supply apparatus configured in the nonuse state, according to an exemplary embodiment. In the nonuse state, the cam 3 may be positioned with a flat portion of the cam 3 placed on or in contact with the pump module 2, the long end 32 of the cam is provided at a side (e.g., at the left side of the pivot in FIG. 4A), the short end 33 is at a different side (e.g., the right side of the pivot in FIG. 4A). Accordingly, no force is applied on the pump module 2 by the cam in the nonuse state. Also in the nonuse state, the cam 3 is positioned at a distance away from the motion bar 81, and the motion bar 81 may also abut against the cam 3, but the cam 3 does not exert any force on the motion bar 81. Therefore, when the liquid supply apparatus is in the nonuse state, the suck-back module 7 is in an initial state or mode. In the initial state of the suck-back module 7, the plug 74 is at the bottom of the cylinder 75, a first chamber 76 is formed or defined by a volume (of the chamber formed by the cylinder 75 and the piston cover 71) that is located above the plug 74. Accordingly, the first chamber 76 is at its maximum volume in the initial state of the suck-back module 7, because the piston rod 73 (and/or plug 74) are at the downward most or bottom positions.

<Liquid Pumping State>

FIG. 4B illustrates the liquid supply apparatus in the liquid-pumping state, according to an exemplary embodiment. Driven by the driving module 4, the cam 3 rotates in a counterclockwise direction around the cam shaft 31, causing the long end 32 of the cam 3 to move to a downward position where the long end 32 presses down on the pump head of the pump module 2 (not shown). For example, the long end 32 may move to a position where it completely and substantially faces the pump head. This position of the cam 3 causes the pump head to move down to pump out some of the liquid stored in the liquid storage tank 1, whereby the liquid flows into the nozzle module 6 along the liquid transport pipe 5, and upon exiting the nozzle module 6, the liquid thereby flows out. In the liquid-pumping state with the cam in the substantially downward position, the short end 33 of the cam 3 faces the motion bar 81, but is configured to not exert any force on the motion bar 81. Accordingly, since the cam 3 still does not exert any force on the motion bar 81, the suck-back module 7 remains in the initial state.

<Liquid Pumping Completion State>

FIG. 4C illustrates the liquid supply apparatus in the liquid pumping completion state, according to an exemplary embodiment. Driven by the driving module 4, the cam 3 rotates farther in the counterclockwise direction to a position where another flat portion of the cam 3 is placed on or in contact with the pump module 2. In this position, the short end 33 of the cam 3 is provided at a side (e.g., the left side of the pivot in FIG. 4C) and the long end 32 is provided at another side (e.g., the right side of the pivot in FIG. 4C), such that no force is applied onto the pump module 2. Accordingly, the cam 3 does not exert any force on the motion bar 81 (as well as the pump module 2) and the suck-back module 7 remains in the initial state. In the liquid pumping completion state or mode, generally a certain amount of the liquid and the liquid-gas mixture remains in the liquid transport pipe 5 and the nozzle module 6.

<Suck-Back State>

FIG. 4D illustrates the liquid supply apparatus in the suck-back state, according to an exemplary embodiment. Driven by the driving module 4, the cam 3 rotates farther in the counterclockwise direction to a position where the long end 32 of the cam 3 moves (e.g., jacks up, displaces, etc.) the motion bar 81. For example, the rotation of the cam 3 may cause the free end 811 of the motion bar 81 to swing upward and thereby drive the connection part 82, which in turn drives the piston rod 73 upward, since the piston rod 73 is connected to the connection part 82. When the piston rod 73 is moved upward in the chamber, a second chamber 77 is formed in the cylinder 75 and the spring 72 is compressed thereby storing energy. As the piston rod 73 moves upward in the chamber, the volume of the second chamber 77 is increased and the volume of the first chamber 76 is reduced. When the long end 32 of the cam 3 completely and substantially faces the motion bar 81, the piston rod 73 is lifted to the highest point at this moment, and the volume of the second chamber 77 reaches the maximum volume as well. During the lifting process, a negative pressure is generated in the second chamber 77 causing the liquid remaining in the liquid transport pipe 5 and the nozzle module 6 to be sucked (e.g., withdrawn, retracted, etc.) into the second chamber 77 along the first return pipe 53 via the first check valve 56. During this process, the short end 33 of the cam 3 is configured to abut the pump head and, therefore, does not exert any force onto the pump module 2.

<Recovering State >

FIG. 4E illustrates the liquid supply apparatus in the recovering state, according to an exemplary embodiment. Driven by the driving module 4, the cam 3 continues to rotate in the counterclockwise direction to a position where the long end 32 of the cam 3 begins to move (e.g., fall back) to the initial state. Additionally, the stored energy in the spring 72 acts to bias or push the piston rod 73 in the downward direction, which acts to increase the volume of the first chamber 76 and reduce the volume of the second chamber 77. The downward movement of the piston rod 73 also may move the plug 74 thereby pressing the liquid in the second chamber 77 into the second return pipe 54, which may enter the liquid storage tank via the second check valve 57. Thus, the recovering process of the residual liquid and liquid-gas mixture is completed. During this process, the short end 33 of the cam 3 may be configured to abut the pump head, but may not exert any force onto the pump module 2. Since the first check valve 56 is configured to let the liquid only enter the second chamber 77 from the first return pipe 51, the liquid will not enter the first return pipe 53 again via the first check valve 56 during the process in which the liquid is pressed into the second return pipe 54. During the process in which the liquid is sucked (e.g., withdrawn, retracted) into the second chamber 77, similarly, the liquid will not enter from the second check valve 57.

Since a suck-back module is added to the liquid supply apparatus, the suck-back module 7 sucks the liquid remaining in the liquid transport pipe 5 and the nozzle module 6 after each use, back into the liquid storage pipe and/or the chamber of the suck-back module 7. The operation of the suck-back module 7 may be controlled by the transmission module 8 and/or the driving module 4 to effectively avoid the dripping and contamination of the residual liquid, in order to save the liquid and extend the shelf life and/or service life of the liquid.

In the exemplary embodiment shown in FIGS. 4A-4E, the cam 3 is configured to rotate in a counterclockwise direction. However, it is noted that according to other embodiments, the cam 3 may also be configured to rotate clockwise or both clockwise and counterclockwise. For example, the cam 3 configured to rotate clockwise may have a position during an initial state where the short end 33 of the cam 3 is located at the left side and the long end 32 of the cam 3 is located at the right side, such as relative to the pivot of the cam 3.

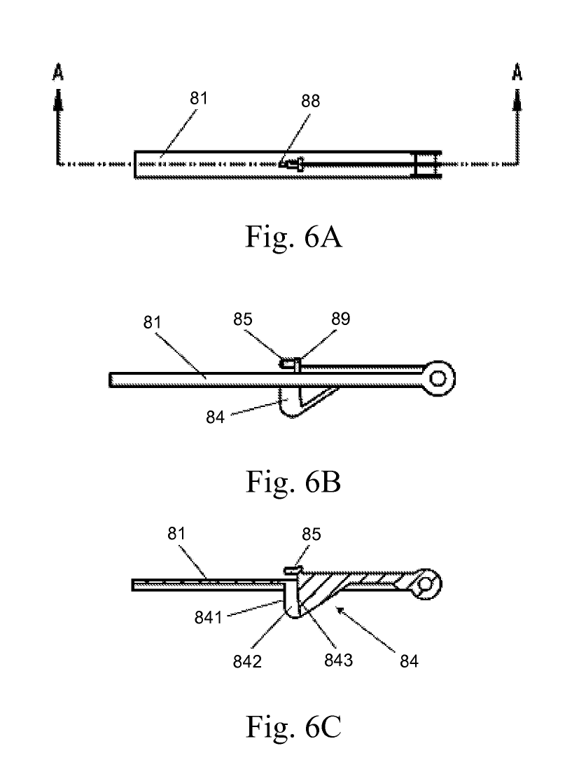

According to the exemplary embodiment shown in FIG. 6A, the motion bar 81 includes an opening 88 and a projection formed at the top surface of the motion bar 81 at the position corresponding to the opening 88. For example, the projection may be formed at a position near the opening of the motion bar 81. The connection part 82 may be configured to be coupled to the projection and extend through the opening in the motion bar 81. For example, the connection part 82 may be hung to the projection by running through the opening 88. However, the method of connecting or coupling the motion bar and the connection part is not limited to the above method, as any suitable method may be employed. For example, a hook may also be disposed on a bottom surface of the motion bar 81 for hanging the connection part 82 thereon. Accordingly, any other methods that allows for connecting the motion bar and the connection part is intended to be encompassed by the scope of the present application.

As shown in FIG. 6B, the projection is configured as a support rod 85, which may have any suitable shape, such as cylindrical. The cylindrical support rod 85 may be integrally formed with or formed separately then installed on a square support base 89. The cylindrical support rod 85 may be provided above a top surface of the motion bar 81 on the square support base 89 at a distance from the opening 88 to reserve the space needed to install the connection part 82. In other words, the support rod 85 may be offset from the motion bar 81 to accommodate a portion of the connection part 82 being disposed therebetween.

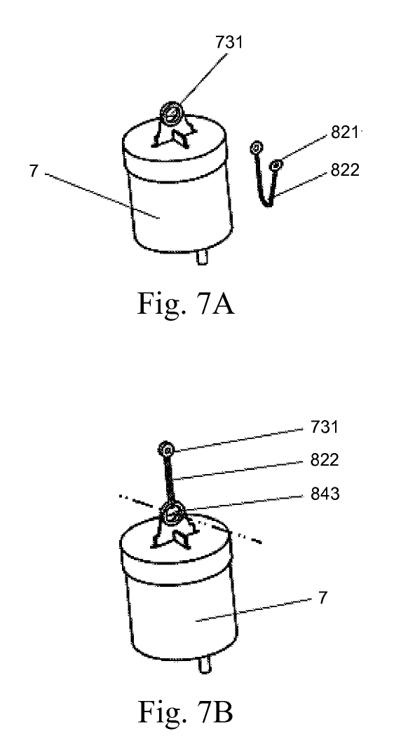

As shown in FIG. 7A, the connection part 82 is configured as a flexible connection rope 822, which may include a ring end 821 configured to be fitted over the cylindrical support rod 85. As shown in FIG. 7B, the piston rod 73 may include a piston hole 731 that is configured to receive the connection rope 822. After running the connection rope 822 through the piston hole 731, the connection rope 822 may be folded generally in the center, such that a pair of ring ends 821 are substantially adjacent and configured to fit over the cylindrical support rod 85. The flexible connection rope 822 may also be connected to the cylindrical support rod 85 by other means, such as winding around the support rod 85 or by tying the connection rope 822 in a knot, and those methods disclosed herein are not limiting. The flexible connection rope 822 may ensure that during the lifting process (e.g., of the piston rod 73), it remains stable without swinging or tilting. According to other embodiments, the connection part 82 may be a rigid connection rod. For example, a first end of the rigid connection rod may be connected fixedly to the motion bar 81 and a second opposing end may be moveably (e.g., slideably) connected to the piston rod 73. Also, for example, the rigid connection rod may have both ends moveably connected to the motion bar 81 and piston rod 73, respectively.

Also shown in FIG. 6B, the motion bar 81 includes a portion 84 that is configured to support the connection rope 822 during the lifting process (e.g., of the piston rod 73). The portion 84 may be formed at a side of the opening 88, such as on the bottom surface of the motion bar 82, and may be provided on the side of the motion bar 81 that is closest to the fixed end 812. The portion 84 may have any suitable shape, such as a triangular shape, which is configured to support the connection rope 822, such as during the lifting process.

The portion 84 may include a side, which may correspond to the position of the opening 88. This side of the portion 84 may extend downward to form a curved edge. For example, the portion 84 may include a curved edge provided adjacent to the opening of the motion bar 81. The curved edge may enable the connection rope 822 to transition smoothly, and may help prohibit the connection rope 822 from being broken during the process of lifting the piston rod 73.

The portion may have a groove that is formed or provided on the curved edge. The groove may help hold the connection rope 822 and may more stably support the connection rope 822.

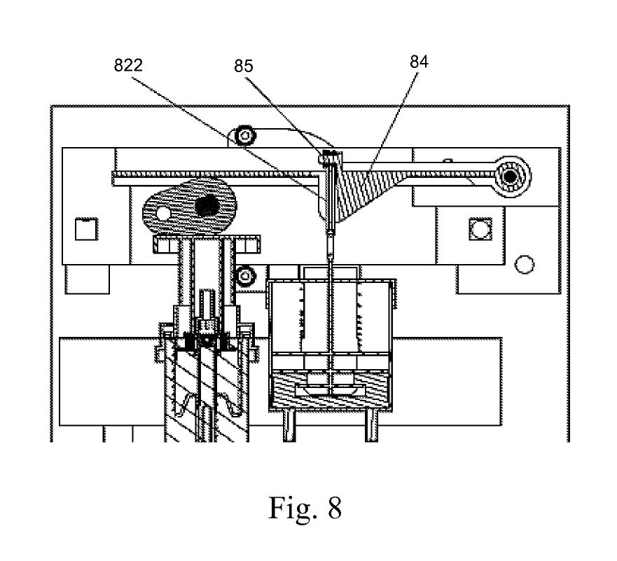

As shown in FIG. 6C, a side of the portion 84 is positioned perpendicular to the motion bar 81 to thereby form a vertical side 841. The vertical side 841 may be provided with a through hole 842 that corresponds to the position of the opening 88. As shown in FIG. 8, the connection rope 822 extends (e.g., runs, passes, etc.) through the through hole 842 and is connected to the cylindrical support rod 85.

The side edge 843 of the longitudinal section of the through hole 842 that is closest to the fixed end 812 may be a curve. The curved side edge 843 may enable the flexible connection rope 822 to transition smoothly, and may help prohibit the connection rope 822 from not being broken during the process of lifting the piston rod 73.

Also shown in FIG. 2, the liquid transport pipe 5 includes a first liquid transport pipe 51 and a second liquid transport pipe 52. An end of the first liquid transport pipe 51 may be connected to the pump module 2, and an end of the second liquid transport pipe 52 may be connected to the nozzle module 6. The liquid transport pipe 5 may also include a three-way connection module 55, where the three-way connection module 55 is connected to the first liquid transport pipe 51, the second liquid transport pipe 52, and the first return pipe 53, respectively.

The liquid storage tank 1 is configured to store any suitable liquid, such as a liquid soap and/or a disinfectant liquid, a softener, a shower gel, a shampoo, or a hand cleanser (e.g., sanitizing) liquid. However, it is noted that the liquid storage tanks 1 of the liquid supply apparatuses, as disclosed herein, are not limited to storing the above specified liquids. Any liquid substance or semi-solid or fluid that needs to be used in small quantities for a number of times may be stored in the liquid storage tanks 1 used in the liquid supply apparatuses as disclosed herein.

It is noted that the embodiments of the liquid supply apparatuses as disclosed herein are meant as examples and are not limiting. It is further noted that variations of the liquid supply apparatuses as disclosed herein may be made, such as by one skilled in the art, and still operate within the spirit of the apparatuses disclosed herein, and accordingly, such variations are intended to be encompassed by the scope of the present application.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the liquid supply apparatuses and suck-back modules as shown in the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A liquid supply apparatus, comprising:
a liquid storage tank;
a pump module connected to the liquid storage tank, the pump module being disposed at a side of a cam and configured to engage the cam;
a driving module for controlling the rotation of the cam;
a liquid transport pipe having a first end connected to the pump module and a second end connected to a nozzle module;
a suck-back module;
a transmission module connected to the suck-back module, the transmission module having an end that is disposed at a second side of the cam and is configured to abut the cam;
a first return pipe having a first end connected to the suck-back module and a second end connected to the liquid transport pipe, the first return pipe having a first check valve disposed therein; and
a second return pipe having a first end connected to the liquid storage tank and a second end connected to the suck-back module, the second return pipe having a second check valve disposed therein.

2. The liquid supply apparatus of claim 1, wherein the suck-back module includes:
a chamber formed by a piston cover disposed at an end of a cylinder;
a piston rod having a first end disposed in the chamber and a second end configured to extend through an opening in the piston cover;
a plug disposed in the chamber and connected to the first end of the piston rod;
a biasing member disposed in the chamber and configured to bias the piston rod relative to the one of the piston cover and the cylinder.

3. The liquid supply apparatus of claim 2, wherein the plug is attached to an inner surface of a wall of the cylinder, and wherein the biasing member has a first end configured to abut the plug and a second end configured to abut an inner surface of the piston cover.

4. The liquid supply apparatus of claim 2, wherein the transmission module includes:
a motion bar having a free end configured to engage the cam and a fixed end pivotally connected to a fixed base; and
a connection part having a first end connected to the motion bar and a second end connected to the piston rod.

5. The liquid supply apparatus of claim 4, wherein the motion bar has an opening and a projection formed on a top surface at a position near the opening of the motion bar, and wherein the connection part is configured to be coupled to the projection and extend through the opening of the motion bar.

6. The liquid supply apparatus of claim 5, wherein the projection is a cylindrical support rod that is provided on a support base.

7. The liquid supply apparatus of claim 6, wherein the connection part is a flexible connection rope having a ring end configured to fit over the cylindrical support rod.

8. The liquid supply apparatus of claim 7, wherein the motion bar includes a portion formed at a side of the opening of the motion bar on a bottom surface of the motion bar.

9. The liquid supply apparatus of claim 8, wherein the portion of the motion bar includes a curved edge provided adjacent to the opening of the motion bar.

10. The liquid supply apparatus of claim 9, wherein a groove is provided on the curved edge.

11. The liquid supply apparatus of claim 8, wherein the portion of the motion bar has a side that is perpendicular to the bottom surface of the motion bar and forms a vertical side having a through hole that corresponds to the position of the opening of the motion bar.

12. The liquid supply apparatus of claim 11, wherein the through hole has a longitudinal section with a curved side edge that is located close to the fixed end of the motion bar.

13. The liquid supply apparatus of claim 4, wherein the the connection part is a rigid connection rod.

14. The liquid supply apparatus of claim 1, wherein the liquid transport pipe includes:
a first liquid transport pipe having an end connected to the pump module;
a second liquid transport pipe having an end connected to the nozzle module; and
a three-way connection module that is connected to the first liquid transport pipe, the second liquid transport pipe, and the first return pipe.

15. The liquid supply apparatus of claim 1, wherein the liquid storage tank is configured to store one of a liquid soap, a disinfectant liquid, a softener, a shower gel, a shampoo, and a hand cleanser liquid.

16. A suck-back module for use in a liquid supply apparatus, the suck-back module comprising:
a chamber formed by a piston cover disposed at an end of a cylinder;
a piston rod having a first end disposed in the chamber and a second end configured to extend through an opening in the piston cover; and
a plug disposed in the chamber and connected to the first end of the piston rod.

17. The suck-back module of claim 16, further comprising a biasing member disposed in the chamber and configured to bias the piston rod relative to the one of the piston cover and the cylinder.

18. The suck-back module of claim 17, wherein the plug is attached to an inner surface of a wall of the cylinder, and wherein the biasing member has a first end configured to abut the plug and a second end configured to abut an inner surface of the piston cover.

19. A liquid supply apparatus, comprising:
a driving module for controlling the rotation of a cam;
a pump module configured to pump a liquid to a transport pipe;
a return pipe having a first end, a second end fluidly connected to the transport pipe, and a check valve provided between the first and second ends;
a suck-back module fluidly connected to the first end of the return pipe and configured to suck-back the liquid in the transport pipe and the return pipe, the suck-back module including;
a chamber formed by a cover disposed at an end of a cylinder, and
a piston rod having a piston portion disposed in the chamber and a rod portion extending from the piston portion through an opening in the cover; and
a transmission module connected to the rod portion of the piston rod and configured to move, such that movement of the transmission module moves the rod portion;
wherein the operation of the pump module and the transmission module are configured to be controlled by the rotation of the cam.

20. The liquid supply apparatus of claim 2, wherein the transmission module includes a connection part and a motion bar having a free end configured to be driven by the cam and a fixed end pivotally connected to a fixed base, wherein the connection part has a first end connected to the motion bar and a second end connected to the rod portion of the piston rod.
